(19) United States
(12) Patent Application Publication
(10) Pub. No.: US 2026/0083104 A1
(43) Pub. Date: Mar. 26, 2026

(54) WATER PURIFICATION SYSTEM AND METHOD FOR INDUSTRIAL LITOPENAEUS VANNAMEI AQUACULTURE

(71) Applicant: TONGWEI AGRICULTURAL DEVELOPMENT CO., LTD., Chengdu (CN)

(72) Inventors: Lu ZHANG, Chengdu (CN); Tao TENG, Chengdu (CN); Haifeng MI, Chengdu (CN); Li CAI, Chengdu (CN); Chunyun LU, Chengdu (CN); Tingting LI, Chengdu (CN)

(73) Assignee: TONGWEI AGRICULTURAL DEVELOPMENT CO., LTD., Chengdu (CN)

(21) Appl. No.: 18/707,615

(22) PCT Filed: Oct. 13, 2023
(86) PCT No.: PCT/CN2023/124538

§ 371 Date: May 6, 2024

(30) Foreign Application Priority Data
Oct. 11, 2023 (CN) 202311317396.8

(51) Int. Cl. A01K 63/04; A01K 61/59; A01K 63/00; C02F 1/00; C02F 1/50; C02F 7/00; C02F 9/00; C02F 103/20

(52) U.S. Cl. CPC A01K 63/042; A01K 61/59; A01K 63/003; A01K 63/045; C02F 1/001; C02F 1/50; C02F 7/00; C02F 9/00; C02F 2103/20; C02F 2209/06; C02F 2209/22

(57) ABSTRACT

A water purification system for industrial Litopenaeus Vannamei aquaculture includes a treatment tank, a bearing platform, and an aquaculture tank, where the treatment tank is fixed to the bearing platform, the aquaculture tank is fixed to the bearing platform, and an isolation plate is fixed in the treatment tank. The isolation plate is provided with a first water hole, the isolation plate divides the treatment tank into an overflow area and a purification and oxygenation area, and the purification and oxygenation area communicates with a pipeline at a bottom of the aquaculture tank. A flow-dividing assembly is fixed in the overflow area, a dredging assembly is fixed to a bottom of the overflow area, and a filter assembly is fixed in the purification and oxygenation area. The filter assembly includes a filter tank, and a disinfection tank is fixed to a side wall of the treatment tank.

### CROSS REFERENCE TO THE RELATED APPLICATIONS

This application is the national phase entry of International Application No. PCT/CN2023/124538, filed on Oct. 13, 2023, which is based upon and claims priority to Chinese Patent Application No. 202311317396.8, filed on Oct. 11, 2023, the entire contents of which are incorporated herein by reference.

### TECHNICAL FIELD

The present disclosure relates to the technical field of water treatment, and in particular, to a water purification system and a method for industrial Litopenaeus Vannamei aquaculture.

### BACKGROUND

As a big country in aquatic products, China ranks first in the world in aquatic products output, and is the only country in the world where aquaculture output exceeds fishing output. In recent years, with the improvement of residents'consumption level, the demand for aquatic protein from ordinary fish has gradually turned to the demand for famous, special and excellent aquatic animals. Survey data of China media consumption center for aquatic prefabricated dishes shows that the category with the maximum demand is Litopenaeus Vannamei, which grows fast, is delicious, has rich nutrition, and is convenient to eat, with rapidly developed aquaculture and rapidly increased consumption in recent years. However, due to water pollution, spread of diseases, and the like during aquaculture, conventional aquaculture is limited, which greatly affects aquaculture efficiency. To solve these problems, major enterprises in the industry begin to invest more money and manpower to research and develop industrial shrimp aquaculture.

Industrial aquaculture can reduce manpower input and resource consumption, and improve economic benefits of aquaculture. However, the industrial aquaculture has a high cost and a high technology threshold in the early stage. For example, the density of the industrial shrimp aquaculture is much greater than that of conventional aquaculture. The technical key point of the industrial aquaculture is a closed circulating water system and how to reduce a comprehensive daily average water exchange quantity and effectively control water quality during the whole aquaculture, to make a water quality index of the whole aquaculture more stable and reduce stress to shrimps caused by deterioration of water quality, thereby improving an aquaculture success rate, and ensuring controllable tail water discharge to comply with environmental protection requirements. Therefore, when this technology is implemented, it is necessary to comprehensively consider various factors and formulate a reasonable aquaculture plan and management strategy to ensure aquaculture benefits and environmental sustainability.

There have been many studies on a circulating water utilization system of industrial shrimp aquaculture, and there are different emphases according to respective environments and modes. For example, Chinese patent application No. CN108174816B discloses a water recycling system for rural aquaculture, including a machine body, where a partition plate is arranged in the machine body, and a water pump is arranged at a top of the machine body. A water outlet of the water pump is arranged at the top of the machine body on a side of the partition plate, and a cleaning mechanism is arranged at a bottom of the interior of the machine body below the water outlet of the water pump. The partition plate is provided with a first opening, and a frame is arranged below the first opening on a side of the partition plate away from the cleaning mechanism. A fine sand layer is arranged above steel wire meshes, and a medium sand layer is arranged between the steel wire meshes. A plurality of tubes are arranged in the fine sand layer, the medium sand layer, and a coarse sand layer. An end of each of the tubes sequentially penetrates through a side of the machine body and a side of a case to be arranged in the case, the tubes are provided with a plurality of liquid outlet holes, and one side of the machine body below the frame is provided with a water outlet.

Although in the patent, the plurality of tubes are arranged in the fine sand layer, the medium sand layer, and the coarse sand layer, and the tubes are provided with the plurality of liquid outlet holes to implement disinfection of water, yet mixing efficiency of a disinfectant and the water is low due to a limited contact space between the disinfectant and the water, which leads to unobvious disinfection efficiency.

### SUMMARY

Embodiments of the present application provide a water purification system and a method for industrial Litopenaeus Vannamei aquaculture, to solve the technical problems of low mixing efficiency of a disinfectant and water and unobvious disinfection efficiency in the prior art.

An embodiment of the present disclosure provides a water purification system for industrial Litopenaeus Vannamei aquaculture, including a treatment tank, a bearing platform, and an aquaculture tank, where the bearing platform is horizontally arranged and is in a cuboid shape, and the treatment tank is fixed to the bearing platform; the treatment tank is hollow, and the treatment tank is in a cuboid shape; the aquaculture tank is fixed to the bearing platform and located on a side of the treatment tank, and the aquaculture tank is in a recessed tank shape; and
a filter assembly is fixed in the treatment tank, and a disinfection tank is fixed to a side wall of the treatment tank; the disinfection tank is located above the aquaculture tank, and the disinfection tank is hollow and a feeding port is provided at a top of the disinfection tank; a disinfection tube is fixed in the treatment tank, and the disinfection tube is horizontally arranged, with a rectangular overall contour; an input end of the disinfection tube penetrates through side walls of the treatment tank and the disinfection tank to extend into the disinfection tank; the disinfection tube is distributed in a grid shape, and the disinfection tube is provided with a plurality of disinfection holes.

As an improvement, the filter assembly includes a filter tank, the filter tank is in a cuboid shape, side surfaces of the filter tank opposite to a top wall and a bottom wall of the treatment tank are provided with a plurality of through holes, two steel wire meshes are fixed to an inner wall of the filter tank, the steel wire meshes are horizontally arranged to divide the filter tank into three filter areas, the three filter areas away from a top wall of the filter tank are sequentially a fine sand layer, a medium sand layer, and a coarse sand layer, and the disinfection tube is located in the fine sand layer, the medium sand layer and the coarse sand layer; and a filter mesh is fixed to a bottom of the filter tank.

As an improvement, an isolation plate is fixed in the treatment tank, and the isolation plate is perpendicular to the bottom wall of the treatment tank; the isolation plate is provided with a first water hole, and the first water hole is located in a part of the isolation plate away from a bottom of the treatment tank; the isolation plate divides the treatment tank into an overflow area and a purification and oxygenation area, and the purification and oxygenation area communicates with a bottom pipeline of the aquaculture tank; and a water outlet end of the aquaculture tank is connected to an external reservoir; and
a flow-dividing assembly is fixed in the overflow area, a dredging assembly is fixed to a bottom of the overflow area, the flow-dividing assembly includes a flow-dividing plate and a plurality of flow-dividing holes, and the flow-dividing plate is in a cuboid shape; the flow-dividing plate is fixed to side walls of the treatment tank and the isolation plate; the flow-dividing plate is horizontally arranged and located above the first water hole, and the flow-dividing plate is provided with the plurality of flow-dividing holes provided at intervals.

As an improvement, the dredging assembly includes a cylinder fixed to a side of the treatment tank, one end of the cylinder communicates with the treatment tank, a motor is fixed to the other end of the cylinder by means of a connecting frame, and a rotating shaft is connected in the cylinder; the rotating shaft is horizontally arranged, one end of the rotating shaft rotates and penetrates through a side wall of the cylinder to be fixedly connected to an output shaft of the motor, the other end of the rotating shaft extends into the treatment tank to be rotatably connected to the isolation plate, a plurality of spiral blades are fixed to the rotating shaft, a bottom of the cylinder is provided with a dredging port, and a sealing cover is connected to the cylinder below the dredging port.

As an improvement, the purification and oxygenation area internally includes a flow guide assembly, the flow guide assembly includes two horizontally arranged flow guide plates, the flow guide plates are fixed to the side walls of the treatment tank and the isolation plate, each of the flow guide plates is provided with one second water hole in each of a vertical direction and a horizontal direction, the two second water holes are provided away from each other in the horizontal direction, and the top wall of the treatment tank in the purification and oxygenation area is provided with an air hole.

As an improvement, the disinfection tube in the filter tank is externally sleeved with a water permeable tube, the water permeable tube is in a grid shape, an inner diameter of the water permeable tube is greater than an outer diameter of the disinfection tube, the water permeable tube is provided with a plurality of water permeable holes, a diameter of each of the water permeable holes is less than a diameter of each particle in the fine sand layer, the medium sand layer and the coarse sand layer in which the water permeable holes are located, and a mixing area is formed between an inner wall of the water permeable tube and an outer wall of the disinfection tube.

As an improvement, an air pump is fixed to a top of the treatment tank, and the disinfection tube is spiral; the disinfection tube is made of an elastic material, a part of the disinfection tube close to the input end communicates with an air injection tube, an input end of the air injection tube communicates with an output end of the air pump, a check valve is fixed to the input end of the disinfection tube, and a cross-sectional diameter of the disinfection tube is half of a cross-sectional diameter of the water permeable tube.

As an improvement, the water purification system for industrial Litopenaeus Vannamei aquaculture further includes a water pump, where the water pump is fixed to a side surface of the treatment tank facing away from the bearing platform, a water inlet end of the water pump is connected to the external reservoir, and a water outlet of the water pump penetrates the top wall of the treatment tank to extend into the treatment tank.

As an improvement, the water purification system for industrial Litopenaeus Vannamei aquaculture further includes a plurality of supporting legs, where the plurality of supporting legs at bottom are fixed to a bottom of the bearing platform, and each of the supporting legs is in a cone frustum shape.

A method for industrial Litopenaeus Vannamei aquaculture with feed, including the following steps:
S1: starting a water pump (500) to inject water into a treatment tank (100) through a reservoir, and allowing the water to undergo flow division by a flow-dividing plate (111) to enter an overflow area (103);
S2: allowing a water level in the overflow area (103) to rise, and allowing the water to enter a purification and oxygenation area (104) through a first water hole (102); and allowing the water to undergo circulation, dredging, filtration, oxygenation, and disinfection, and then enter an aquaculture tank (400);
S3: allowing the water to undergo flow division by through holes in a top wall of a filter tank (131) to sequentially enter a fine sand layer (133), a medium sand layer (134) and a coarse sand layer (135) for filtration, and during this process, allowing a disinfectant in a disinfection tank (150) to enter the fine sand layer (133), the medium sand layer (134), the coarse sand layer (135) through disinfection holes (153) of a disinfection tube (152) for uniform mixing with the water and disinfection;
S4: allowing the filtered and disinfected water to fall onto a flow guide plate (141) via through holes at a bottom of the filter tank (131), and allowing the water to flow on the flow guide plate (141) and then fall down through a second water hole (142);
S5: allowing the water to enter the aquaculture tank (400) through a pipeline at a bottom of the treatment tank (100);
S6: performing fertilizer and water treatment before stocking Litopenaeus Vannamei;
S7: adjust a water temperature to 22-25° C., a water pH to 7.6, and salinity to 6%%;
S8: putting young Litopenaeus Vannamei in the aquaculture tank (400), and regularly feeding shrimp baits, where the shrimp bait includes a fortifier, a body-building material, a meat-increasing material, and the like;
S9: during an aquaculture period, allowing the water and residues to enter the reservoir through a water outlet end of the aquaculture tank (400) for precipitation;
S10: cleaning the reservoir regularly; and
S11: culturing the young Litopenaeus Vannamei for about 65 days and then fishing adult shrimps.

One or more technical solutions provided in the embodiments of the present application have at least the following technical effects or advantages:

First, the disinfection tube is distributed in a grid shape in the fine sand layer, the medium sand layer, and the coarse sand layer, so that the disinfectant is fully contacted and mixed with the filtered water, and the disinfection effect is improved; in addition, the disinfection tube is arranged in a horizontal plane as a whole in the fine sand layer, the medium sand layer and the coarse sand layer, so that compared with the prior art, the disinfection tube is more stable, the risk of the disinfection tube deviating from the plane due to the influence of water flow, so that there are different disinfectant outflow volumes at different positions and the disinfectant is not evenly mixed with the water is reduced, and stability of water disinfection is improved.

Second, the disinfection tube in the filter tank is externally sleeved with a water permeable tube, and a mixing area is formed between the inner wall of the water permeable tube and the outer wall of the disinfection tube, thereby further improving the mixing effect, thus further improving the disinfection effect; in addition, the arrangement of the water permeable tube can effectively prevent the particles in the fine sand layer, the medium sand layer and the coarse sand layer from entering the mixing area, reduce the risk of the disinfection holes in the disinfection tube being blocked by the particles and the disinfection effect being affected, thereby further improving disinfection stability.

Third, the air pump is fixed to the top of the treatment tank, and the disinfection tube is spiral; the disinfection tube is made of the elastic material, a part of the disinfection tube close to the input end communicates with the air injection tube, the input end of the air injection tube communicates with the output end of the air pump, the check valve is fixed to the input end of the disinfection tube, and the cross-sectional diameter of the disinfection tube is half of the cross-sectional diameter of the water permeable tube. When the disinfection tube expands, the disinfectant can flow to different positions in the mixing area through the disinfection holes to be mixed with the water, and can be mixed with the water on different cross sections of the mixing area, so that the mixing effect is further improved, and the disinfection effect is further strengthened.

### BRIEF DESCRIPTION OF THE DRAWINGS

FIG. 1 is a schematic diagram of an overall structure of Embodiment 1 of the present disclosure;

FIG. 2 is a schematic diagram showing arrangement of a disinfection tube according to Embodiment 1 of the present disclosure;

FIG. 3 is a schematic cross-sectional view of the disinfection tube according to Embodiment 1 of the present disclosure;

FIG. 4 is a schematic diagram showing fitting between a water permeable tube and a disinfection tube according to Embodiment 2 of the present disclosure;

FIG. 5 is a schematic cross-sectional view of the water permeable tube and the disinfection tube according to Embodiment 2 of the present disclosure;

FIG. 6 is a schematic diagram of a water permeable tube according to Embodiment 3 of the present disclosure;

FIG. 7 is a schematic diagram showing fitting between the water permeable tube and the disinfection tube according to Embodiment 3 of the present disclosure; and

FIG. 8 is a diagram showing an operating state of the disinfection tube according to Embodiment 3 of the present disclosure.

In the figures: 100. Treatment tank; 101. Isolation plate; 102. First water hole; 103. Overflow area; 104. Purification and oxygenation area; 200. Bearing platform; 300. Supporting leg; 400. Aquaculture tank; 500. Water pump; 110. Flow-dividing assembly; 111. Flow-dividing plate; 112. Flow-dividing hole; 120. Dredging assembly; 121. Cylinder; 122. Motor; 123. Rotating shaft; 124. Spiral blade; 125. Dredging port; 126. Sealing cover; 130. Filter assembly; 131. Filter tank; 132. Steel wire mesh; 133. Fine sand layer; 134. Medium sand layer; 135. Coarse sand layer; 136. Filter mesh; 140. Flow guide assembly; 141. Flow guide plate; 142. Second water hole; 150. Disinfection tank; 151. Feeding port; 152. Disinfection tube; 153. Disinfection hole; 154. Water permeable tube; 155. Water permeable hole; 156. Mixing area; 157. Air injection tube; 158. Check valve.

### DETAILED DESCRIPTION OF THE EMBODIMENTS

To facilitate the understanding of the present disclosure, the present application will be described more fully below with reference to the relevant accompanying drawings. Preferred implementations of the present disclosure are shown in the accompanying drawings, but the present disclosure can be implemented in many different forms and is not limited to the implementations described herein. On the contrary, these implementations are provided for a more thorough and comprehensive understanding of the disclosed content of the present disclosure.

It should be noted that the terms “vertical”, “horizontal”, “upper”, “lower”, “left”, “right” and other similar expressions used herein are for illustrative purposes only, rather than to mean the only implementation.

Unless otherwise defined, all technical and scientific terms used herein have same meanings as those generally understood by those skilled in the art to which the present disclosure belongs. The terms used herein in the specification of the present disclosure are intended only to describe the specific implementations and are not intended to restrict the present disclosure. The terms “and/or” used herein includes any combination or all combinations of one or more related listed items.

In a water purification system for industrial Litopenaeus Vannamei aquaculture according to the present application, a disinfection tube 152 in a grid shape is arranged in fine sand layer 133, medium sand layer 134, and coarse sand layer 135, so that full mixing of a disinfectant and water is improved, and a disinfection effect is improved. In addition, the disinfection tube 152 is arranged in a horizontal plane as a whole in the fine sand layer 133, the medium sand layer 134 and the coarse sand layer 135, so that compared with the prior art, the disinfection tube 152 is more stable, the risk of the disinfection tube 152 deviating from the horizontal plane due to the influence of water flow, so that there are different disinfectant outflow volumes at different positions and thus the disinfectant is not evenly mixed with the water is reduced, and stability of water disinfection is improved.

### Embodiment 1

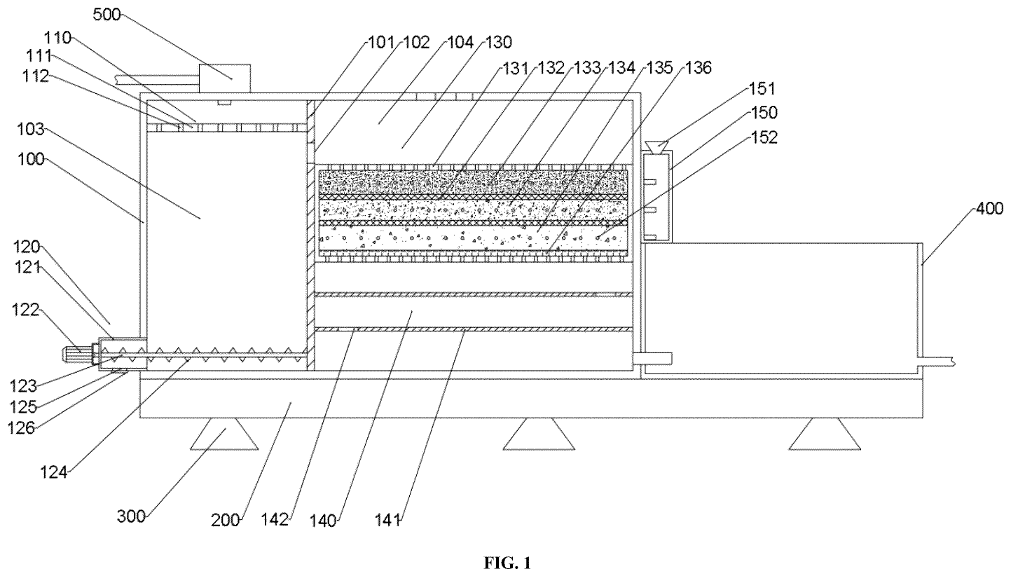

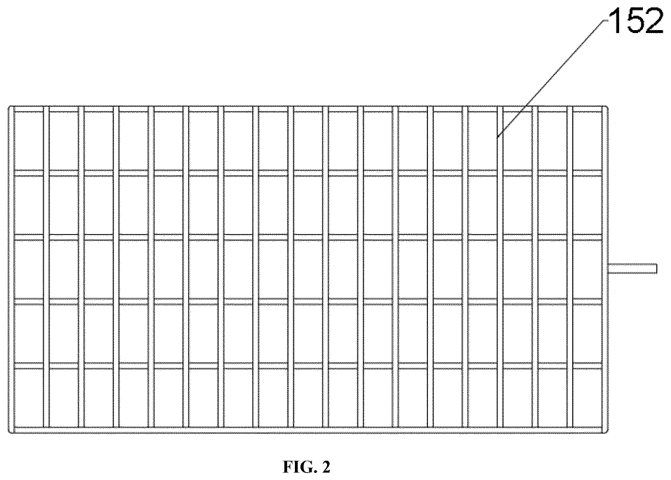

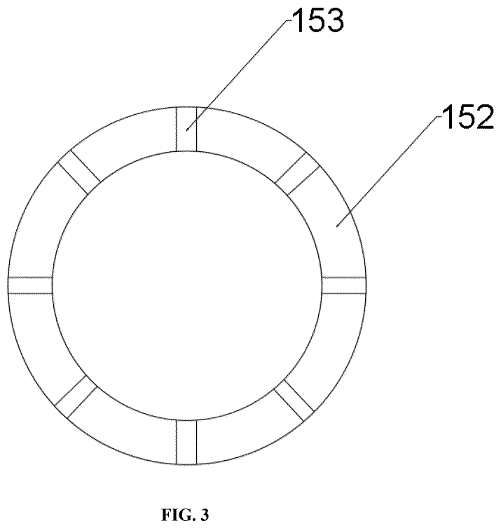

A water purification system for industrial Litopenaeus Vannamei aquaculture shown in FIGS. 1-3 includes treatment tank 100, bearing platform 200, supporting legs 300, aquaculture tank 400, and water pump 500. The bearing platform 200 is horizontally arranged and is in a cuboid shape.

A plurality of supporting legs 300 are fixed to a bottom of the bearing platform 200, and each of the supporting legs 300 is in a cone frustum shape.

The treatment tank 100 is fixed to a side surface of the bearing platform 200 facing away from the supporting legs 300, and the treatment tank 100 is hollow. The treatment tank 100 is in a cuboid shape.

The aquaculture tank 400 is fixed to the side surface of the bearing platform 200 facing away from the supporting legs 300, and on a side of the treatment tank 100, and the aquaculture tank 400 is in a recessed tank shape.

Water pump 500 is fixed to a side surface of the treatment tank 100 facing away from the bearing platform 200, a water inlet end of the water pump 500 is connected to an external reservoir, and a water outlet of the water pump 500 penetrates a top wall of the treatment tank 100 to extend into the treatment tank 100.

Isolation plate 101 is fixed in the treatment tank 100, and the isolation plate 101 is perpendicular to a bottom wall of the treatment tank 100.

The isolation plate 101 is provided with first water hole 102, and the first water hole 102 is located in a part of the isolation plate 101 away from a bottom of the treatment tank 100.

The isolation plate 101 divides the treatment tank 100 into overflow area 103 and purification and oxygenation area 104, and the top wall of the treatment tank 100 in the purification and oxygenation area 104 is provided with an air hole.

The purification and oxygenation area 104 communicates with a bottom pipeline of the aquaculture tank 400. A water outlet end of the aquaculture tank 400 is connected to the external reservoir, and the reservoir can be used to implement manual centralized treatment of aquaculture waste and avoid water pollution.

Flow-dividing assembly 110 is fixed in the overflow area 103, and the flow-dividing assembly 110 includes flow-dividing plate 111 and a plurality of flow-dividing holes 112. The flow-dividing plate 111 is in a cuboid shape. The flow-dividing plate 111 is fixed to side walls of the treatment tank 100 and the isolation plate 101. The flow-dividing plate 111 is horizontally arranged and located above the first water hole 102, and the flow-dividing plate 111 is provided with the plurality of flow-dividing holes 112 provided at intervals.

Dredging assembly 120 is fixed to a bottom of the overflow area 103, and the dredging assembly 120 includes cylinder 121 fixed to a side of the treatment tank 100. One end of the cylinder 121 communicates with the treatment tank 100, motor 122 is fixed to the other end of the cylinder 121 by means of a connecting frame, and rotating shaft 123 is connected in the cylinder 121. The rotating shaft 123 is horizontally arranged. One end of the rotating shaft 123 rotates and penetrates through a side wall of the cylinder 121 to be fixedly connected to an output shaft of the motor 122, and the other end of the rotating shaft 123 extends into the treatment tank 100 to be rotatably connected to the isolation plate 101. A plurality of spiral blades 124 are fixed to the rotating shaft 123, a bottom of the cylinder 121 is provided with dredging port 125, and sealing cover 126 is connected to the cylinder 121 below the dredging port 125.

Filter assembly 130 is fixed in the purification and oxygenation area 104, and the filter assembly 130 includes filter tank 131. The filter tank 131 is in a cuboid shape, and side surfaces of the filter tank 131 opposite to the top wall and the bottom wall of the treatment tank 100 are provided with a plurality of through holes. Two steel wire meshes 132 are fixed to an inner wall of the filter tank 131, and the steel wire meshes 132 are horizontally arranged to divide the filter tank 131 into three filter areas. The three filter areas away from a top wall of the filter tank 131 are sequentially fine sand layer 133, medium sand layer 134, and coarse sand layer 135, and filter mesh 136 is fixed to a bottom of the filter tank 131.

Disinfection tank 150 is fixed to a side wall of the treatment tank 100. The disinfection tank 150 is located above the aquaculture tank 400, and the disinfection tank 150 is hollow and provided with feeding port 151 at top. A disinfection tube 152 is fixed in the fine sand layer 133, the medium sand layer 134, and the coarse sand layer 135, and the disinfection tube 152 is horizontally arranged, with a rectangular overall contour. An input end of the disinfection tube 152 penetrates through side walls of the treatment tank 100 and the disinfection tank 150 to extend into the disinfection tank 150. The disinfection tube 152 is distributed in a grid shape in the fine sand layer 133, the medium sand layer 134, and the coarse sand layer 135, and the disinfection tube 152 is provided with a plurality of disinfection holes 153.

The purification and oxygenation area 104 internally further includes flow guide assembly 140, and the flow guide assembly 140 includes two horizontally arranged flow guide plates 141. The flow guide plates 141 are fixed to the side walls of the treatment tank 100 and the isolation plate 101. Each of the flow guide plates 141 is provided with one second water hole 142 in each of a vertical direction and a horizontal direction, and the two second water holes 142 are provided away from each other in the horizontal direction.

During use, the water pump 500 is started, and the water pump 500 pumps water in the reservoir into the treatment tank 100, and the water undergoes flow division by the flow-dividing plate 111, to prevent the water from falling directly and generating a great impact force. The water level rises in the overflow area 103, and the water flows into the purification and oxygenation area 104 through the first through hole 102. The water undergoes flow division by through holes in the top wall of the filter tank 131 to sequentially enter the fine sand layer 133, the medium sand layer 134 and the coarse sand layer 135. During this process, a disinfectant in the disinfection tank 150 enters the fine sand layer 133, the medium sand layer 134 and the coarse sand layer 135 through the disinfection holes 153 of the disinfection tube 152 for uniform mixing with the water and disinfection, and the sterilized water falls onto the flow guide plate 141 through a through hole at the bottom of the filter tank 131. The water flows on the flow guide plate 141 and then falls through the second water hole 142. An oxygen content of the water is increased by increasing a water flow path. The water enters the aquaculture tank 400 through the bottom pipeline of the treatment tank 100, and the used water is discharged from the water outlet end of the aquaculture tank 400 into the reservoir, so as to implement overall circulation, dredging, filtration, oxygenation, and disinfection.

During dredging, the sealing cover 126 is opened, the motor 122 is started to rotate the rotating shaft 123, the rotating shaft 123 rotates the spiral blades 124, and the spiral blades 124 discharge deposited sludge through the dredging port 125. After the sludge is discharged, the motor 122 stops operating, and the dredging port 125 is sealed by the sealing cover 126.

Compared with the prior art, the disinfection tube 152 is distributed in a grid shape in the fine sand layer 133, the medium sand layer 134, and the coarse sand layer 135, so that the disinfectant is fully contacted and mixed with the filtered water, and the disinfection effect is improved; in addition, the disinfection tube 152 is arranged in a horizontal plane as a whole in the fine sand layer 133, the medium sand layer 134 and the coarse sand layer 135, so that compared with the prior art, the disinfection tube 152 is more stable, the risk of the disinfection tube 152 deviating from the plane due to the influence of water flow, so that there are different disinfectant outflow volumes at different positions and the disinfectant is not evenly mixed with the water is reduced, and stability of water disinfection is improved.

A method for industrial Litopenaeus Vannamei aquaculture with feed, including the following steps.
S1: Water pump (500) is started to inject water into treatment tank (100) through a reservoir, and the water undergoes flow division by a flow-dividing plate (111) to enter overflow area (103).
S2: A water level in the overflow area (103) rises, and the water enters purification and oxygenation area (104) through first water hole (102).

The water undergoes circulation, dredging, filtration, oxygenation, and disinfection, and then enters aquaculture tank (400).
S3: The water undergoes flow division by through holes in a top wall of a filter tank (131) to sequentially enter fine sand layer (133), medium sand layer (134) and coarse sand layer (135) for filtration, and during this process, a disinfectant in disinfection tank (150) enters the fine sand layer (133), the medium sand layer (134), the coarse sand layer (135) through disinfection holes (153) of disinfection tube (152) for uniform mixing with the water and disinfection.
S4: The filtered and disinfected water falls onto flow guide plate (141) via through holes at a bottom of the filter tank (131), and the water flows on the flow guide plate (141) and then falls down through second water hole (142).
S5: The water enters the aquaculture tank (400) through a pipeline at a bottom of the treatment tank (100).
S6: Fertilizer and water treatment is performed before stocking Litopenaeus Vannamei.
S7: A water temperature is adjusted to 22-25° C., a water pH is adjusted to 7.6, and salinity is adjusted to 6%.
S8: Young Litopenaeus Vannamei is put in the aquaculture tank (400), and shrimp baits are regularly fed, where the shrimp bait includes a fortifier, a body-building material, a meat-increasing material, and the like.
S9: During an aquaculture period, the water and residues enter the reservoir through a water outlet end of the aquaculture tank (400) for precipitation.
S10: The reservoir is cleaned regularly.
S11: The young Litopenaeus Vannamei is fed for about 65 days and then adult shrimps are fished.

### Embodiment 2

To further enhance the disinfection effect, this embodiment is further improved based on Embodiment 1.

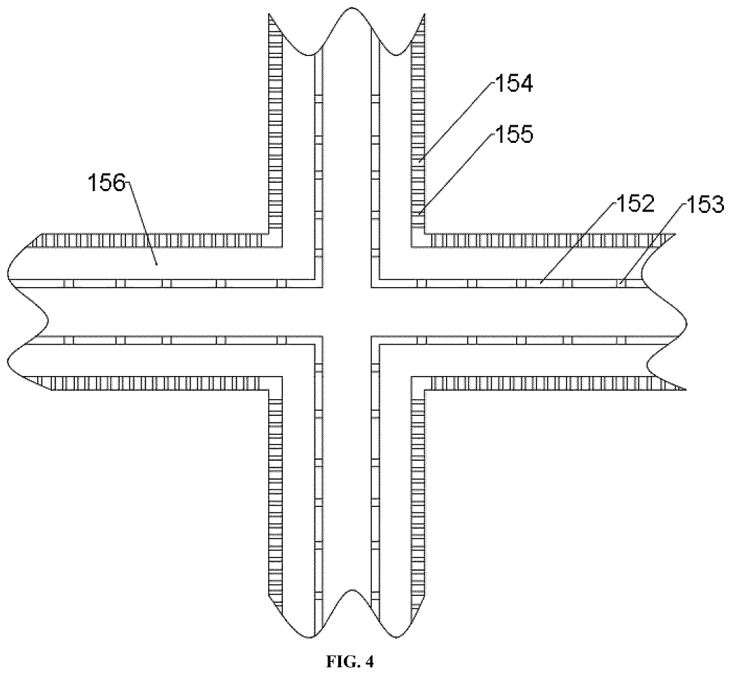

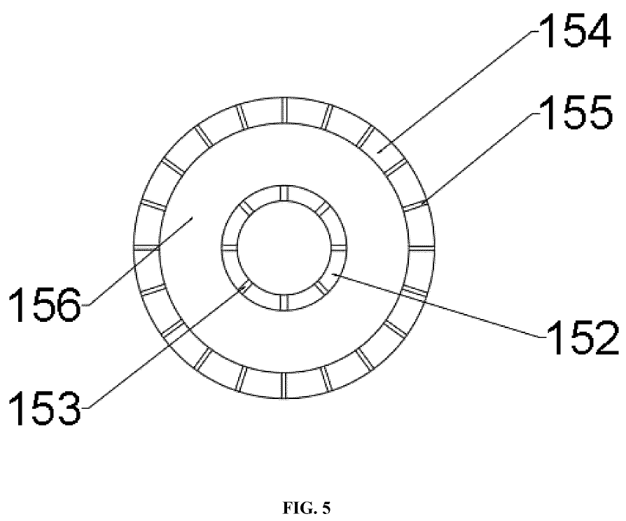

As shown in FIGS. 4-5, in this embodiment, the disinfection tube 152 in the filter tank 131 is externally sleeved with water permeable tube 154, the water permeable tube 154 is in a grid shape, an inner diameter of the water permeable tube 154 is greater than an outer diameter of the disinfection tube 152, the water permeable tube 154 is provided with a plurality of water permeable holes 155, a diameter of each of the water permeable holes 155 is less than a diameter of each particle in the fine sand layer 133, the medium sand layer 134 and the coarse sand layer 135 in which the water permeable holes are located, and mixing area 156 is formed between an inner wall of the water permeable tube 154 and an outer wall of the disinfection tube 152.

During use, water enters the mixing area 156 through the water permeable holes 155 in the water permeable tube 154, a disinfectant enters the mixing area 156 through the disinfection holes 153 in the disinfection tube 152, and the disinfectant and the water can be fully mixed in the mixing area 156, thereby further improving the mixing effect, thus further improving the disinfection effect; in addition, the arrangement of the water permeable tube 154 can effectively prevent the particles in the fine sand layer 133, the medium sand layer 134 and the coarse sand layer 135 from entering the mixing area 156, reduce the risk of the disinfection holes 153 in the disinfection tube 152 being blocked by the particles and the disinfection effect being affected, thereby further improving disinfection stability.

### Embodiment 3

To further enhance the disinfection effect, this embodiment is further improved based on Embodiment 2.

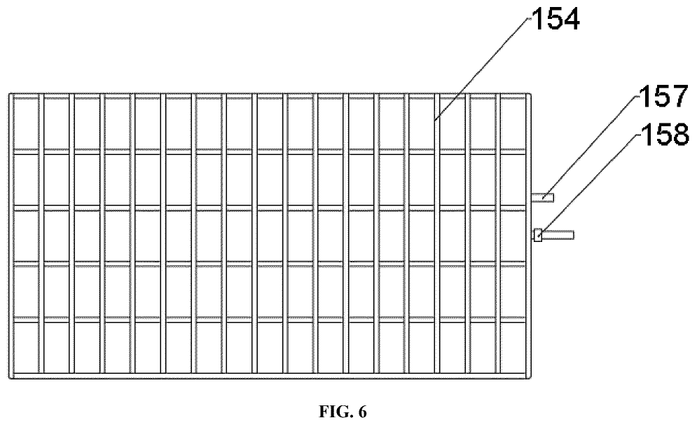

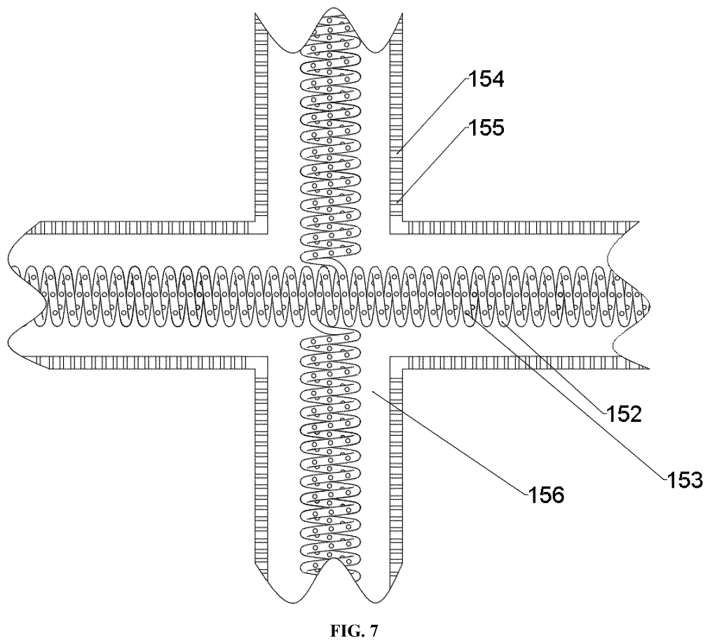

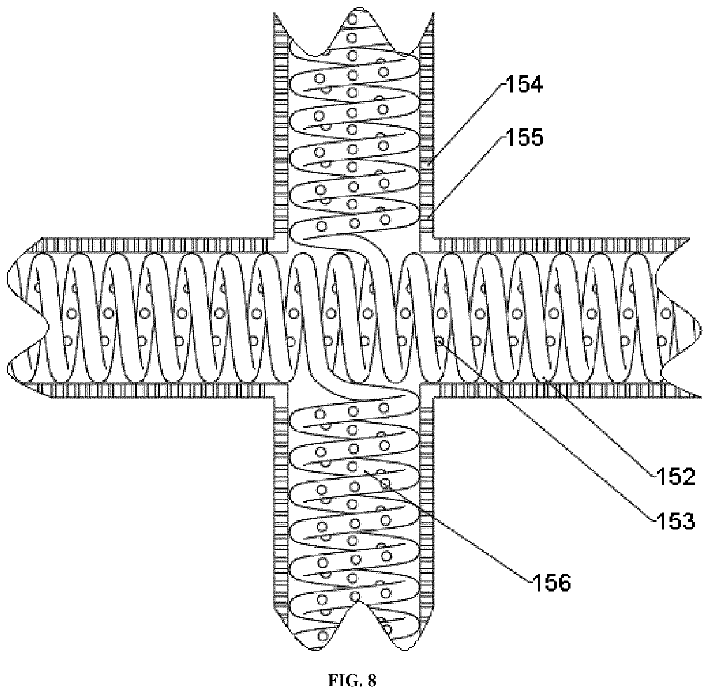

As shown in FIGS. 6-8, in this embodiment, an air pump is fixed to a top of the treatment tank 100, and the disinfection tube 152 is spiral; the disinfection tube 152 is made of an elastic material, a part of the disinfection tube 152 close to the input end communicates with air injection tube 157, an input end of the air injection tube 157 communicates with an output end of the air pump, check valve 158 is fixed to the input end of the disinfection tube 152, and a cross-sectional diameter of the disinfection tube 152 is half of a cross-sectional diameter of the water permeable tube 154.

During use, water enters the mixing area 156 through the water permeable holes 155 in the water permeable tube 154, and a disinfectant enters the filter tank 131 through the check valve 158. The air pump is started, and the disinfection tube 152 can be expanded by controlling different output power of the air pump. Compared with that of Embodiment 2, the disinfectant in the spiral disinfection tube 152 flows out uniformly to the mixing area 156 through the disinfection holes 153, so that a disinfectant flow path becomes longer and a disinfectant outflow volume increases. In addition, when the disinfection tube 152 expands, the disinfectant can flow to different positions in the mixing area 156 through the disinfection holes 153 to be mixed with the water, and can be mixed with the water on different cross sections of the mixing area 156, so that the mixing effect is further improved, and the disinfection effect is further strengthened.

The foregoing descriptions are merely preferred implementations of the present disclosure and are not intended to limit the present disclosure, and various modifications and changes of the present disclosure may be made by those skilled in the art. Any modifications, equivalent substitutions, improvements, and the like made within the spirit and scope of the present disclosure should fall within the protection scope of the present disclosure.

What is claimed is:

1. A water purification system for an industrial Litopenaeus Vanname aquaculture, comprising a treatment tank, a bearing platform, and an aquaculture tank, wherein the bearing platform is horizontally arranged and is in a cuboid shape, and the treatment tank is fixed to the bearing platform the treatment tank is hollow, and the treatment tank is in a cuboid shape; the aquaculture tank is fixed to the bearing platform and located on a side of the treatment tank, and the aquaculture tank is in a recessed tank shape; and
a filter assembly 130 is fixed in the treatment tank, and a disinfection tank is fixed to a side wall of the treatment tank; the disinfection tank is located above the aquaculture tank, and the disinfection tank is hollow and a feeding port is provided at a top of the disinfection tank; a disinfection tube is fixed in the treatment tank, and the disinfection tube is horizontally arranged, with a rectangular overall contour; an input end of the disinfection tube penetrates through side walls of the treatment tank and the disinfection tank to extend into the disinfection tank; the disinfection tube is distributed in a grid shape and is provided with a plurality of disinfection holes.

2. The water purification system for the industrial Litopenaeus Vannamei aquaculture according to claim 1, wherein the filter assembly comprises a filter tank, the filter tank is in a cuboid shape, side surfaces of the filter tank opposite to a top wall and a bottom wall of the treatment tank are provided with a plurality of through holes, two steel wire meshes are fixed to an inner wall of the filter tank, the two steel wire meshes are horizontally arranged to divide the filter tank into three filter areas, the three filter areas away from a top wall of the filter tank are sequentially a fine sand layer, a medium sand layer, and a coarse sand layer, and the disinfection tube is located in the fine sand layer, the medium sand layer and the coarse sand layer; and a filter mesh is fixed to a bottom of the filter tank.

3. The water purification system for the industrial Litopenaeus Vannamei aquaculture according to claim 1, wherein an isolation plate is fixed in the treatment tank, and the isolation plate is perpendicular to a bottom wall of the treatment tank; the isolation plate is provided with a first water hole, and the first water hole is located in a part of the isolation plate away from a bottom of the treatment tank; the isolation plate divides the treatment tank into an overflow area and a purification and oxygenation area and the purification and oxygenation area communicates with a bottom pipeline of the aquaculture tank; and a water outlet end of the aquaculture tank is connected to an external reservoir; and
a flow-dividing assembly is fixed in the overflow area a dredging assembly is fixed to a bottom of the overflow area, the flow-dividing assembly comprises a flow-dividing plate and a plurality of flow-dividing holes, and the flow-dividing plate is in a cuboid shape; the flow-dividing plate is fixed to side walls of the treatment tank and the isolation plate the flow-dividing plate is horizontally arranged and located above the first water hole and the flow-dividing plate is provided with the plurality of flow-dividing holes provided at intervals.

4. The water purification system for the industrial Litopenaeus Vannamei aquaculture according to claim 3, wherein the dredging assembly comprises a cylinder fixed to the side of the treatment tank, a first end of the cylinder communicates with the treatment tank, a motor is fixed to a second end of the cylinder by a connecting frame, and a rotating shaft is connected in the cylinder; the rotating shaft is horizontally arranged, a first end of the rotating shaft rotates and penetrates through a side wall of the cylinder to be fixedly connected to an output shaft of the motor, a second end of the rotating shaft extends into the treatment tank to be rotatably connected to the isolation plate a plurality of spiral blades are fixed to the rotating shaft a bottom of the cylinder is provided with a dredging port, and a sealing cover is connected to the cylinder below the dredging port.

5. The water purification system for the industrial Litopenaeus Vannamei aquaculture according to claim 3, wherein the purification and oxygenation area internally comprises a flow guide assembly, the flow guide assembly comprises two horizontally arranged flow guide plates, the two horizontally arranged flow guide plates are fixed to the side walls of the treatment tank and the isolation plate each of the two horizontally arranged flow guide plates is provided with a second water hole in each of a vertical direction and a horizontal direction, the second water holes in each of the vertical direction and the horizontal direction is provided away from each other in the horizontal direction, and a top wall of the treatment tank in the purification and oxygenation area is provided with an air hole.

6. The water purification system for the industrial Litopenaeus Vannamei aquaculture according to claim 1, wherein the disinfection tube in the filter tank is externally sleeved with a water permeable tube the water permeable tube is in a grid shape, an inner diameter of the water permeable tube is greater than an outer diameter of the disinfection tube, the water permeable tube is provided with a plurality of water permeable holes, a diameter of each of the plurality of water permeable holes is less than a diameter of each particle in the fine sand layer, the medium sand layer and the coarse sand layer in which the plurality of water permeable holes are located, and a mixing area is formed between an inner wall of the water permeable tube and an outer wall of the disinfection tube.

7. The water purification system for the industrial Litopenaeus Vannamei aquaculture according to claim 6, wherein an air pump is fixed to a top of the treatment tank, and the disinfection tube is spiral; the disinfection tube is made of an elastic material, a part of the disinfection tube adjacent to the input end communicates with an air injection tube an input end of the air injection tube communicates with an output end of the air pump, a check valve is fixed to the input end of the disinfection tube and a cross-sectional diameter of the disinfection tube is half of a cross-sectional diameter of the water permeable tube.

8. The water purification system for the industrial Litopenaeus Vannamei aquaculture according to claim 1, further comprising a water pump, wherein the water pump is fixed to a side surface of the treatment tank facing away from the bearing platform, a water inlet end of the water pump is connected to an external reservoir, and a water outlet of the water pump penetrates a top wall of the treatment tank to extend into the treatment tank.

9. The water purification system for the industrial Litopenaeus Vannamei aquaculture according to claim 1, further comprising a plurality of supporting legs wherein the plurality of supporting legs at bottom are fixed to a bottom of the bearing platform, and each of the plurality of supporting legs is in a cone frustum shape.

10. A method for an industrial Litopenaeus Vannamei aquaculture, using the water purification system for the industrial Litopenaeus Vannamei aquaculture according to claim 1, comprising the following steps:
S1: starting a water pump to inject water into the treatment tank through a reservoir, and allowing the water to undergo a first flow division by a flow-dividing plate to enter an overflow area;
S2: allowing a water level in the overflow area to rise, and allowing the water to enter a purification and oxygenation area through a first water hole and allowing the water to undergo circulation, dredging, filtration, oxygenation, and disinfection, and then enter the aquaculture tank;
S3: allowing the water to undergo a second flow division by through holes in a top wall of a filter tank to sequentially enter a fine sand layer, a medium sand layer, and a coarse sand layer for filtration, and during the process, allowing a disinfectant in the disinfection tank to enter the fine sand layer, the medium sand layer, the coarse sand layer through the plurality of disinfection holes of the disinfection tube for uniform mixing with the water and the disinfection to obtain a filtered and disinfected water;
S4: allowing the filtered and disinfected water to fall onto a flow guide plate via through holes at a bottom of the filter tank, and allowing the filtered and disinfected water to flow on the flow guide plate and then fall down through a second water hole
S5: allowing the filtered and disinfected water to enter the aquaculture tank through a pipeline at a bottom of the treatment tank;
S6: performing a fertilizer and water treatment before stocking the Litopenaeus Vannamei;
S7: adjust a water temperature to 22-25° C., a water pH to 7.6, and a salinity to 6%%;
S8: putting young Litopenaeus Vannamei in the aquaculture tank, and regularly feeding a shrimp bait, wherein the shrimp bait comprises a fortifier, a body-building material, and a meat-increasing material;
S9: during an aquaculture period, allowing water and residues produced in the aquaculture period to enter the reservoir through a water outlet end of the aquaculture tank for precipitation;
S10: cleaning the reservoir regularly; and
S11: culturing the young Litopenaeus Vannamei for 65 days and then fishing adult shrimps.

11. The method for the industrial Litopenaeus Vannamei aquaculture according to claim 10, wherein in the water purification system for the industrial Litopenaeus Vannamei aquaculture, the filter assembly comprises the filter tank, the filter tank is in a cuboid shape, side surfaces of the filter tank opposite to a top wall and a bottom wall of the treatment tank are provided with a plurality of through holes, two steel wire meshes are fixed to an inner wall of the filter tank, the two steel wire meshes are horizontally arranged to divide the filter tank into three filter areas, the three filter areas away from the top wall of the filter tank are sequentially the fine sand layer, the medium sand layer, and the coarse sand layer, and the disinfection tube is located in the fine sand layer, the medium sand layer and the coarse sand layer; and a filter mesh is fixed to the bottom of the filter tank.

12. The method for the industrial Litopenaeus Vannamei aquaculture according to claim 10, wherein in the water purification system for the industrial Litopenaeus Vannamei aquaculture, an isolation plate is fixed in the treatment tank, and the isolation plate is perpendicular to a bottom wall of the treatment tank; the isolation plate is provided with the first water hole, and the first water hole is located in a part of the isolation plate away from a bottom of the treatment tank; the isolation plate divides the treatment tank into the overflow area and the purification and oxygenation area, and the purification and oxygenation area communicates with a bottom pipeline of the aquaculture tank; and the water outlet end of the aquaculture tank is connected to the external reservoir; and
a flow-dividing assembly is fixed in the overflow area, a dredging assembly is fixed to a bottom of the overflow area, the flow-dividing assembly comprises the flow-dividing plate and a plurality of flow-dividing holes, and the flow-dividing plate is in a cuboid shape; the flow-dividing plate is fixed to side walls of the treatment tank and the isolation plate; the flow-dividing plate is horizontally arranged and located above the first water hole, and the flow-dividing plate is provided with the plurality of flow-dividing holes provided at intervals.

13. The method for the industrial Litopenaeus Vannamei aquaculture according to claim 12, wherein in the water purification system for the industrial Litopenaeus Vannamei aquaculture, the dredging assembly comprises a cylinder fixed to the side of the treatment tank, a first end of the cylinder communicates with the treatment tank, a motor is fixed to a second end of the cylinder by a connecting frame, and a rotating shaft is connected in the cylinder; the rotating shaft is horizontally arranged, a first end of the rotating shaft rotates and penetrates through a side wall of the cylinder to be fixedly connected to an output shaft of the motor, a second end of the rotating shaft extends into the treatment tank to be rotatably connected to the isolation plate, a plurality of spiral blades are fixed to the rotating shaft, a bottom of the cylinder is provided with a dredging port, and a sealing cover is connected to the cylinder below the dredging port.

14. The method for the industrial Litopenaeus Vannamei aquaculture according to claim 12, wherein in the water purification system for the industrial Litopenaeus Vannamei aquaculture, the purification and oxygenation area internally comprises a flow guide assembly, the flow guide assembly comprises two horizontally arranged flow guide plates, the two horizontally arranged flow guide plates are fixed to the side walls of the treatment tank and the isolation plate, each of the two horizontally arranged flow guide plates is provided with the second water hole in each of a vertical direction and a horizontal direction, the second water hole in each of the vertical direction and the horizontal direction is provided away from each other in the horizontal direction, and a top wall of the treatment tank in the purification and oxygenation area is provided with an air hole.

15. The method for the industrial Litopenaeus Vannamei aquaculture according to claim 11, wherein in the water purification system for the industrial Litopenaeus Vannamei aquaculture, the disinfection tube in the filter tank is externally sleeved with a water permeable tube, the water permeable tube is in a grid shape, an inner diameter of the water permeable tube is greater than an outer diameter of the disinfection tube, the water permeable tube is provided with a plurality of water permeable holes, a diameter of each of the plurality of water permeable holes is less than a diameter of each particle in the fine sand layer, the medium sand layer and the coarse sand layer in which the plurality of water permeable holes are located, and a mixing area is formed between an inner wall of the water permeable tube and an outer wall of the disinfection tube.

16. The method for the industrial Litopenaeus Vannamei aquaculture according to claim 15, wherein in the water purification system for the industrial Litopenaeus Vannamei aquaculture, an air pump is fixed to a top of the treatment tank, and the disinfection tube is spiral; the disinfection tube is made of an elastic material, a part of the disinfection tube adjacent to the input end communicates with an air injection tube, an input end of the air injection tube communicates with an output end of the air pump, a check valve is fixed to the input end of the disinfection tube, and a cross-sectional diameter of the disinfection tube is half of a cross-sectional diameter of the water permeable tube.

17. The method for the industrial Litopenaeus Vannamei aquaculture according to claim 10, wherein the water purification system for the industrial Litopenaeus Vannamei aquaculture further comprises the water pump, the water pump is fixed to a side surface of the treatment tank facing away from the bearing platform, a water inlet end of the water pump is connected to the external reservoir, and a water outlet of the water pump penetrates a top wall of the treatment tank to extend into the treatment tank.

18. The method for the industrial Litopenaeus Vannamei aquaculture according to claim 10, wherein the water purification system for the industrial Litopenaeus Vannamei aquaculture further comprises a plurality of supporting legs, the plurality of supporting legs at bottom are fixed to a bottom of the bearing platform, and each of the plurality of supporting legs is in a cone frustum shape.
